(19) United States
(12) Patent Application Publication
(10) Pub. No.: US 2002/0054148 A1
(43) Pub. Date: May 9, 2002

(54) GUI control method and apparatus and recording medium

(76) Inventor: Hidehiko Okada, Tokyo (JP)

Correspondence Address: David A. Blumenthal, FOLEY & LARDNER, Washington Harbour, 3000 K Street, N.W., Suite 500, Washington, DC, 20007-5109, US

(21) Appl. No.: 09/758,549

(22) Filed: Jan. 12, 2001

(30) Foreign Application Priority Data
Jan. 14, 2000 (JP) 2000-005431

(51) Int. Cl. G09G 5/00

(52) U.S. Cl. 345/810

(57) ABSTRACT

A GUI control method and apparatus and a program facilitating the use of a software even by a beginner user, clarifying the software use, guiding the user in the operating sequence and enabling operation on a screen different from an inherent screen. The use of the software is displayed on a screenshot. If a use is selected, a widget to be operated next is highlighted on the screen in accordance with a pre-registered operating sequence to guide the user in his or her operating sequence. A cover screen hiding the inherent screen of the software is displayed, and the software use is displayed on the cover screen by a menu. If an operation is performed on the cover screen, an operation equivalent to that performed on the cover screen is executed on the inherent screen of the software.

### FIELD OF THE INVENTION

This invention relates to a graphical user interface GUI technique in an information processing apparatus. More particularly, it relates to a GUI control method, program and apparatus for improving the tractability and convenience in use of a software having the GUI and which is run on a computer typified by a personal computer (PC) or a workstation (WS).

### BACKGROUND OF THE INVENTION

In order to make a software, adapted for running on a computer, such as PC or WS, and having the GUI, convenient to use for a user, the applicable use of a software, that is what can be done using the software, and an operational sequence for the use, need to be definite for the user.

In the case of an E-MAIL software, [reading a mail], [sending a mail] and [making an answer] are among the items of the applicable use of the software. It is also desirable that these items of use be readily understood by a user, that is that the user may readily comprehend that he or she is able to read or transmit a mail on the use of the software, and that, if once the applicable use is decided, it may readily be understood in what sequence the software is to be operated in such use.

This condition (demand) is particularly crucial for a beginner user with only poor experience in the computer. If the applicable use of the software is not definite, the user is unable to realize what can be done on the computer, so that the objective in using a computer (what one desires to do on the computer) cannot be achieved. Even if the applicable use of the software are realized, the user is at a loss how to operate the computer, except if the operational sequence is definite. so that again the objective in using a computer cannot be achieved.

FIG. 29 shows a typical conventional screenshot (picture s screen) of a software with GUI adapted for running on a computer, such as PC or WS. In a typical convent ional display of a software with GUI, as shown in FIG. 29, the functions of the software are displayed/represented on a menu or as icons, and the user exploits this software by selecting the menu or icon.

In the case of FIG. 29, [FILE]. [EDIT] and [VIEW] etc. belong to the menu items, with small rectangular widgets shown there below being icons. The numbers of these menu items and icons become larger, the larger, the number of the functions provided in the software.

### SUMMARY OF THE DISCLOSURE

In the typical conventional screenshot of a software with GUI, as described above, the functions provided in the software are displayed by menus or icons, however, the applicable use of the software is not clarified. For examples there are [creating a new document] or [opening and editing a document] among the items of applicable use of the software, a typical screenshot of which is shown in FIG. 29, however, the corresponding applicable use is not clarified on the screenshot shown in FIG. 29.

On the other hand, current software products are mostly not provided with a mechanism for guiding (instructing) an operational sequence for exploiting the software in each applicable use.

So, with a beginner user with only little experience in a computer, it is difficult to achieve the objective of using a software, that is, to realize what he or she wishes.

As methods for displaying the applicable use or guiding the operational sequence of the software, there may be envisaged

(1) a method of endowing the software itself with a mechanism displaying the applicable use or guiding the operational sequence of the software; and

(2) a method of realizing a mechanism operated with the software for displaying the use or guiding the operational sequence of the software from outside the software without changing the program of the software.

In the above method (1) the majority of the pre-existing software is not internally provided with such mechanism. If it is desired to provide a pre-existing software with display of the use and with the operational sequence guiding mechanism, it is necessary to change the software program.

It is usually only the software supplier who can execute such change, while a third party other than the software supplier is unable to change the software to realize the above-mentioned .mechanism.

In the case of the method (2), the mechanism such as indication of use or operational sequence guiding can be realized without changing the pre-existing software. However, there lacks such a method or mechanism which realizes such mechanism.

On the other hand, the number of menu items or icons on the software window becomes larger, the larger the number of the functions provided on the software. As the functions provided on the software becomes diversified, and the number of GUI widgets such as menu items or icons, the operational sequence becomes complicated. In particular, in case of a beginner user with only poor experience in the computer, it is difficult to achieve the objective of using the software.

For a beginner user, or a user who is in need of only a portion of the diversified functions, and who does not exploit other functions, the operational sequence would be clearer if a more simplified presentation is displayed, in which only the GUI widgets required are presented, without presenting the totality of the GUI widgets for the required functions.

As a method for realizing a mechanism of displaying a simplified presentation (screenshot) in place of a presentation (screenshot) inherent to the software, there may be envisaged

(1) a method of providing the software itself with a simplified presentation (screenshot) other than and in place of an inherent presentation (screenshot) of the software; and

(2) a method of not changing the software program, but realizing a mechanism operated with the software for displaying the simplified presentation (screenshot) for viewing by the user from outside the software, for notifying the operation for the presentation (screenshot) as an operation to the inherent presentation (screenshot) of the software, while hiding the inherent presentation (screenshot) without presenting it to the user.

However, with the method (1), the majority of the pre-existing software is not provided with the corresponding internal mechanism, so that, if desired to endow the software with such internal mechanism, the software program needs to be changed. Moreover, it is usually only the software supplier who can execute such change, while a third party other than the software supplier is unable to change the software to realize the above-mentioned mechanism.

On the other hand, in the case of the method (2), the mechanism which allows the user to act on a screenshot different from the screenshot inherent to the software can be realized without changing the pre-existing software. However, there lacks such a method or apparatus which realizes such mechanism.

As a technique relevant to the present invention, there is disclosed in e.g., the JP Patent Kokai JP-A-10-207676 such an arrangement in which, as a guide type application supporting system of learning the operating method of the application software and actual operating, unified together, the operational sequence for the application software and the guide information are saved in a database, and which is made up of application communication means for directly running the selected application software in accordance with the operational sequence saved in the database and, user presentation means for instruct ng the operating method for the application software directly operated by the application communication means by the image and the audio information in accordance with the guide information saved in the database.

There is also disclosed in JP Patent Kokai JP-A-06-019662 a help display device for an information processing apparatus in which, in executing an application program, the operational flow diagram showing the operational sequence in a tree configuration from function to function is prepared and presented to the user, and in which status transition indicating the status transition in the flow diagram for informing the user position by thick arrows and the route to the specified function may also be prepared and presented to the user.

There is also disclosed in JP Patent Kokai JP-A-02-300913 a software program operational sequence instructing device comprised of means for storing in memory means the operational sequence and the processing contents furnished by the software program, comparing the information on the operational sequence fed to input means to the information on the operational sequence and the processing contents furnished by the software program and for verifying the point of difference between the two operational sequences and means for selecting and recommending the operational sequence information most analogous to the operational sequence stored in the memory means based on the checked result.

For example, in the JP Patent Kokai JP-A-11-237978, there is disclosed a graphical user interface forming apparatus in which the co-referencing between the menu item and the GUI widget may be comprehended at a glance.

There is also disclosed in JP Patent Kokai JP-A-11-271539 a GUI picture forming system comprised of a display unit made up of a work area window for displaying a GUI picture, a widget list window for displaying pre-defined widgets, a widget list window for displaying combination widgets defined and registered by the picture purveyor and a tool window for displaying variable control tools, a GUI picture forming system having enclosed therein the combination widget registering process, and a file unit made up of the picture file, widget file and the combination widget file. The picture provider is able to define in combination, register and re-use the widgets of the pre-defined minimum units to furnish a highly efficient tool.

Moreover, here is disclosed in e. g., the JP Patent Kokai JP-A-11-259200 a system and a method for setting user-definable command elements on a user interface in which, when a user desirous to execute a specified program task sets a visual command element on a user interface command necessary for executing the specified task, and selects a proper menu command in subsequently executing the same task, the user may be guided automatically from the visual command elements, such that, if the user selects a specified menu command, the visual command element can be automatically set in the totality of the specified menu commands to be selected in achieving the specified menu command, in which the sequence to be selected in executing a specified task may be automatically set in the specified menu command having a visual command element, and in which the sequence to be selected for the specified menu command having the visual command element to execute a specified task is presented to the user.

As a navigation tool for personal computer operation, there is now commercially available a software produced manufactured by SHARP CO. LTD. under the trade name of [PC navigator] (http://sharp-world.com/sc/excite/soft_map/ces02pn/). With this [PC navigator], if a user queries what he or she desires to know in the natural language and clicks a relevant button, a list of the response to the queried contents is displayed. If then the operation is selected and the relevant button clicked, the personal computer navigator automatically executes the operations. Moreover, since sample pictures or screenshots of the Word and Excel, both being the trademarks owned by Microsoft Corporation, and the Window (R), similarly a registered trademark owned by Microsoft Corporation, are provided, to provide a sample input function, so that an operation the user desires can be found,

However, the above-mentioned problem cannot be settled by these known techniques.

It is therefore an object of the present invention to provide a GUI control method, apparatus and program which clarify the applicable use of an optional software to guide the operational sequence to enable an operation on a presentation (screenshot) different from the inherent screen without modifying the software provided with the GUI, so that even a beginner user will be able to exploit the software readily.

For accomplishing the above object, the present inventors have completed an invention pertinent to a method, an apparatus and a program product as defined in the claims.

According to a first aspect of the present invention, the applicable use of the software is demonstrated in a menu form on a presentation (screenshot) of a display apparatus. If one use is selected on the menu, a GUI (graphical user interface) widget to be acted on next is demonstrated in a configuration outstanding from the surrounding background, in a pre-stored operational sequence. These operations are sequentially carried out to guide the operational sequence for realizing the above use.

According to a second aspect of the present invention, a cover screen hiding an inherent screen of the software may be demonstrated on the display device, wherein the applicable use of the software is demonstrated in a menu form on the cover screens If an operation is performed on the cover screen, an operation equivalent to that performed on the cover screen is then executed on the inherent screen of the software in accordance with a pre-registered relationship with widgets.

Moreover, the present invention includes

(a) a step of previously registering in a storage unit the applicable use of a software adapted for running on a computer. the computer having a GUI,

(b) a step of displaying the registered use as a menu item on a screen of a display device, inputting an operational sequence of the software, as required for utilizing the software in the use, for registration in the storage unit, for each use displayed on the menu; and

(c) a step of booting, on selection of the use from the menu, the software as required for the selected use, of detecting in what location in the screen a GUI widget to be acted on next, in accordance with the operating sequence previously registered for the selected use, and of displaying the detected GUI widget in a highlighted fashion on the screen or picture in accordance with the detected display location for the GUI; and

(d) a step of detecting an operation of said GUI widget, in accordance with the previously registered operating sequence, of detecting in what position on the screen a GUI widget to be o operated next, and of displaying the GUI widget in a highlighted fashion on the screen or picture, in accordance with the next detected display location of the next GUI widget.

The GUI control apparatus includes:

use menu display means for displaying, in a menu, the applicable use of a software adapted for running on a computer, the software having a graphical user interface GUI,

use menu registration means for previously registering a use menu displayed by the use menu display means,

use selection detection means for detecting, on selection of the use from the use menu displayed on the use menu display means, what use has been selected,

software booting means for booting the software required for the selected use,

operational sequence registration means for previously registering the operational sequence for acting on the software in the selected use,

widget detection means for detecting in what location on the screen the GUI widget to be operated next is to be displayed on a screen, in accordance with an operating sequence registered for the selected use,

operation target widget indicating means for displaying the GUI widget detected by the widget detection means in a highlighted fashion on a screen or picture, and

operation detection means for detecting an operation made on a GUI widget detected by the widget detection means and for instructing the widget detection means to detect, in accordance with an operating sequence registered for the selected use, in what location on the screen the next GUI widget to be operated on next is displayed.

Further aspects of the invention are disclosed in the entire claims which are incorporated herein by reference thereto.

### BRIEF DESCRIPTION OF THE DRAWINGS

FIG. 1 shows a configuration of a first embodiment of a GUI control device according to the present invention.

FIG. 2 schematically shows a typical registration of a use menu in the first embodiment of the present invention.

FIG. 3 schematically shows a typical display screenshot of the use menu in the first embodiment of the present invention.

FIG. 4 shows a typical screenshot (displayed picture screen) of the use menu in the first embodiment of the present invention.

FIGS. 5a and 5b show a typical screenshot (picture screen) of the software in the first embodiment of the present invention.

FIG. 6 shows an illustrative operational sequence registered in operational sequence registration means 105 in the first embodiment of the present invention.

FIG. 7 shows a typical display in which a widget designated by an operation target widget indicating unit 106 is shown highlighted in the first embodiment of the present invention.

FIG. 8 shows a typical display in which a widget by the operation target widget indicating unit 110 is shown highlighted in the first embodiment of the present invention.

FIG. 9 shows typical widget display by a widget display unit 108 in the first embodiment of the present invention.

FIG. 10 shows a configuration of a second embodiment of the present invention.

FIG. 11 shows a typical screenshot (displayed picture screen) of the use menu in the second embodiment of the present invention.

FIG. 12 shows a configuration of a third embodiment of the present invention.

FIG. 13 schematically shows a typical registration of the use menu in the third embodiment of the present invention,

FIG. 14 shows a typical registration of the use menu in the third embodiment of the present invention.

FIG. 15 shows a typical registration of the use menu in the third embodiment of the present invention.

FIG. 16 shows a typical relation (correspondence) of widgets registered in the widget-relation information registration unit 1210.

FIG. 17 shows a typical software screenshot (picture screen) in the third embodiment of the present invention.

FIG. 18 shows a typical software screenshot in the third embodiment of the present invention.

FIG. 19 shows a typical cover screen in the third embodiment of the present invention.

FIG. 20 shows a typical relation of widgets registered in the widget-relation information registration unit 1210.

FIG. 21 shows a typical relation of widgets registered in the widget-relation information registration unit 1210.

FIG. 22 shows a typical cover screen in the third embodiment of the present invention.

FIG. 23 shows a typical relation of widgets registered in the widget-relation information registration unit 1210.

FIG. 24 shows a typical relation of widgets-relation information registered in the widget-relation information registration unit 1210.

FIG. 25 shows a typical software screenshot in the third embodiment of the present invention.

FIG. 26 shows a typical software screenshot in the third embodiment of the present invention.

FIG. 27 shows a configuration showing a fourth embodiment of the present invention.

FIG. 28 shows a configuration showing a fifth embodiment of the present invention.

FIG. 29 shows a typical presentation (screenshot) of a software running on a control computer and which has a GUI.

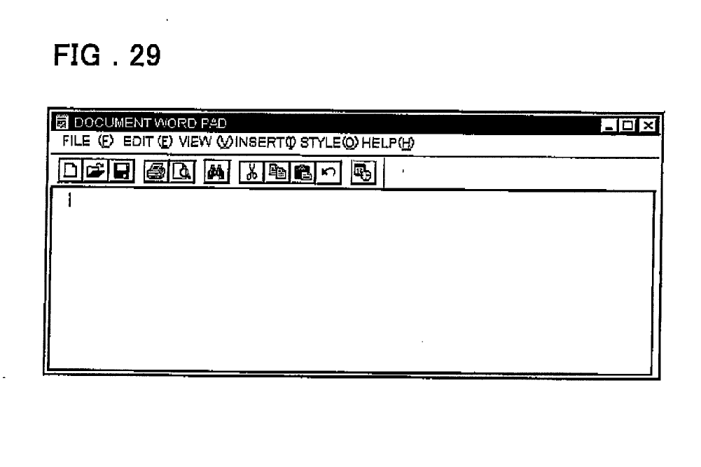

### PREFERRED EMBODIMENTS OF THE INVENTION

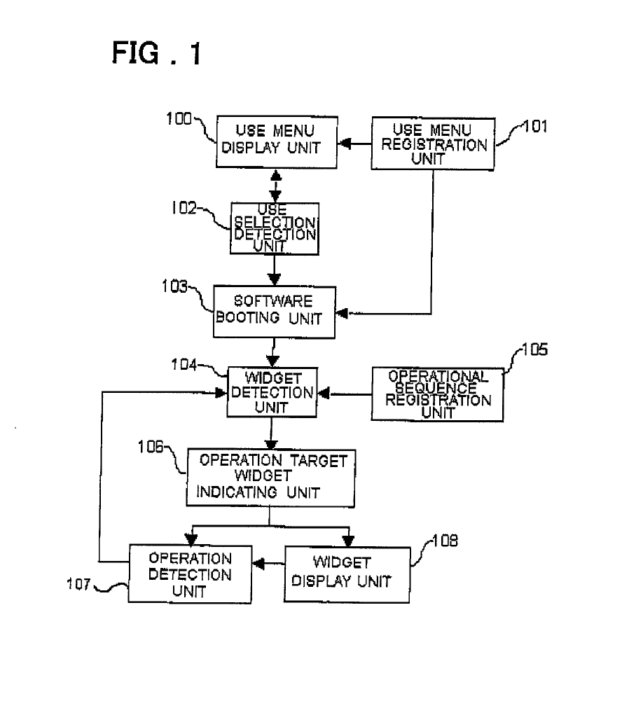

An embodiment of the present invention is explained in detail by referring to the drawings. Referring to FIG. 1 a Gill control apparatus according to a preferred embodiment of the present invention includes use menu display unit 100 for displaying, in a menu, the applicable use of a software adapted for running on a computer and having a graphical user interface GUI, use menu registration unit 101 for previously registering a use menu displayed by the use menu display unit, use selection detection unit 102 for detecting, on selection of the use from the use menu displayed on the use menu display unit, which use has been selected, software booting unit 103 for booting the software required for the selected use, operation sequence registration unit 105 for previously registering the operational sequence for acting on the software in the selected use, widget detection unit 104 for detecting in which location on the screen the GUI widget to be acted on next is to be displayed on a screen or picture, in accordance with an operating sequence registered for the selected use, operation target widget indicating unit 106 for displaying the GUI widget detected by the widget detection unit in a highlighted fashion on a screen or picture, and operation detection unit 107 for detecting an action made on a GUI widget detected by the widget detection unit and for instructing the widget detection unit to detect, in accordance with an operating sequence registered for the selected use, in what location on the screen the GUI widget to be acted on next is displayed.

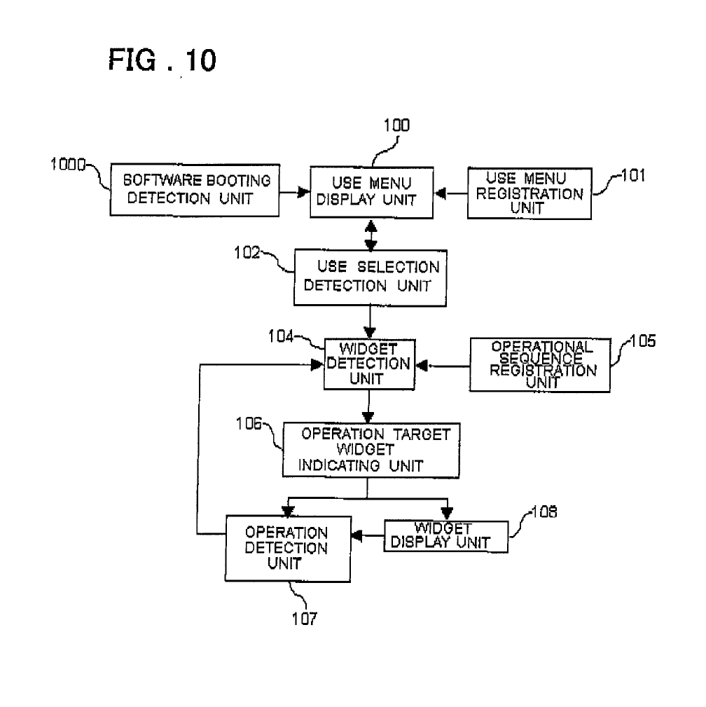

Referring to FIG. 10, another preferred embodiment of the GUI control apparatus according to the present invention includes software booting detecting unit 1000 for detecting booting of a software adapted for running on a computer, the software having a graphical user interface GUI, use menu display unit 100 for displaying, in a menu, the applicable use of a booted software, use menu registration unit 101 for previously registering a use menu displayed by the use menu display unit, use selection detection unit 102 for detecting, on selection of the use from the use menu displayed by the use menu display unit which use has been detected 105 operational sequence registration unit for previously registering an operational sequence for acting on the software in the selected use, widget detection unit 104 for detecting, in accordance with an operational sequence registered for the selected use, by the operational sequence registration unit, in which location on a screen the GUI widget to be acted on next is displayed, operation target widget indicating unit 106 for displaying the GUI widget detected by the widget detection unit 104 in a highlighted fashion on a screen or picture, and operation detection unit 107 for detecting an action on a GUI widget detected by the widget detection unit and for instructing the widget detection unit 104 to detect, in accordance with an operational sequence registered by the operational sequence registration unit, in what location on the screen the GUI widget to be acted on next is displayed.

The present invention includes a unit 108 for displaying a GUI widget for notifying the completion of processing on a current screen, in which the operation detection unit 107 detects an operation performed on the GUI widget detected by the widget detection unit 104 or on the GUI widget displayed by the widget display unit 108.

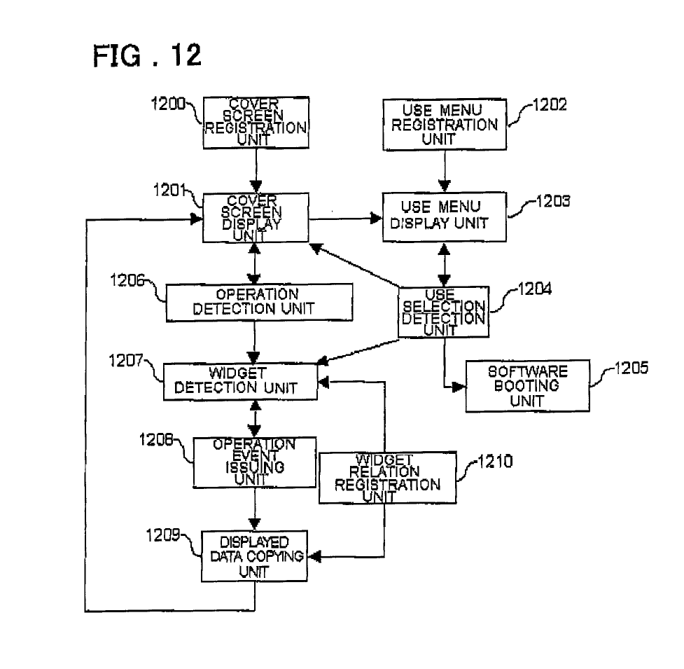

Referring to FIG. 12, another preferred embodiment of the GUI control apparatus according to the present invention includes a use menu displaying unit 1203 for demonstrating on a menu the applicable use of a software operating on a computer, the software having a graphical user interface GUI, use menu registration unit 1202 for previously registering the use menu demonstrated by the use menu displaying unit 1203, use selection detection unit 1204 for detecting the use selected from the use menu demonstrated by the use menu displaying unit 1202, software booting unit 1205 for booting a software necessary for the selected use, cover screen registration unit 1200 for previously registering, as a cover screen, a picture for employing the booted software in the selected use, cover screen display unit 1201 for hiding an inherent screen of the booted software and for visibly demonstrating the cover screen registered by the cover screen registration unit in its stead, operation detection unit 1206 for detecting an operation on the GUI widget demonstrated on the cover screen to instruct the cover screen registration unit 1200 to display the cover screen, widget-relation (correspondence) information registration unit 1210 for previously registering widget-relation information as to which GUI widget on the inherent screen of the software is to be acted on depending on any of the GUI widgets on the cover screen has been acted on, widget detection unit 1207 for detecting, depending on the widget-relation information registered by the widget-relation information registration unit, in what location on the inherent screen of the software the GUI widget to be acted on next is demonstrated, and operation event issuing unit 1208 for issuing an operating event on the GUI widget detected by the widget detection unit 1207. It is previously registered by the widget-relation information registration unit 1210 any of the GUI widgets on the cover screen data displayed in any of the GUI widgets on the inherent screen of the software is to be copied. There is provided displayed data copying unit 1209 for copying the data displayed in a GUI widget on the inherent screen of the software in the GUI widget on the cover screen in accordance with the widget-relation information registered by the widget-relation information registration unit 1210.

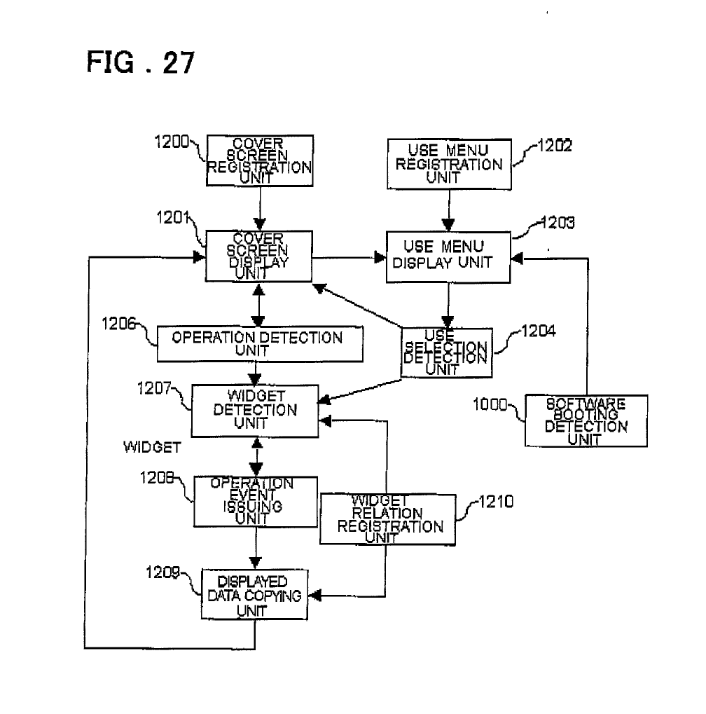

Referring to FIG. 27, still another preferred embodiment of the GUI control apparatus according to the present invention includes use menu registration unit 1202 for previously registering the applicable use of a software, cover screen registration unit 1200 for previously registering a picture for using the software for the application as a cover screen, cover screen displaying unit 1201 for detecting the booting of the software, hiding an inherent screen of the booted software and for visibly demonstrating the cover screen registered by the cover screen registration unit in its stead, use menu displaying unit 1203 for demonstrating the applicable use of the booted software as a menu on the cover screen demonstrated by the cover screen display unit, use selection detection unit 1204 for detecting, on selection of a use from the menu, which use has been selected, operation detection unit 12U6 or detecting an operation on a GUI (graphical user interface) widget displayed on the cover screen, widget-relation information registration unit 1210 for previously registering indicating which GUI widget on an inherent screen on the software is to be actuated upon actuation of any of the GUI widgets on the cover screen, widget detection unit 1207 for detecting in what location on an inherent screen of the software the GUI widget to be acted on next is demonstrated in accordance with widget-relation information registered by the widget-relation information registration unit 1210, and operating event issuing unit 1208 for issuing an operating event for a GUI widget detected by the widget detection unit 1207. It is previously registered by the widget-relation information registration unit 1210 in which GUI widget on the cover screen data displayed in which GUI widget on the inherent screen of the software is to be copied. There is provided displayed data copying unit 1209 for copying the data displayed in a GUI widget on the inherent screen of the software in the GUI widget on the cover screen in accordance with the widget-relation information registered by the widget-relation information registration unit 1210.

The functions and the processing of the above-mentioned respective unit are realized by a program executed on a computer. That is, from a medium, such as a communication medium, carrying the program, the program is read into a computer via a preset interfacing unit and installed, The form of executing the program is loaded on a main memory of the computer and executed to carry out the present invention.

The GUI control method according to the present invention preferably is comprised of the following respective steps:

(a) a step of previously registering in a storage unit the applicable use of a software adapted for running on a computer, without changing the program of the software, the computer having a GUI,

b) a step of displaying the registered use as a menu on a screen of a display device, inputting an operational sequence of the software, as required for utilizing the software in the use, for registration in the storage unit, for each use displayed on the menu.

(c) a step of booting, on selection of the use from the menu, the software as required for the selected use, detecting, by detection unit, in which location in the screen a GUI widget to be acted on next, in accordance with the operating sequence previously registered for th selected use, and of displaying the detected GUI widget in a highlighted fashion on the screen or picture in accordance with the detected display location for the GUI, and

(d) a step of detecting an action of the GUI widget, instructing the detection unit, in accordance with the previously registered operating sequence, to detect in which position on the screen a GUI widget to be acted on next and displaying the GUI widget in a highlighted fashion on the screen or picture, in accordance with the detected display location of the GUI widget.

A GUI control method in another embodiment of the present invention includes

(a) a step of previously registering in a storage unit the applicable use of a software adapted for running on a computer, the computer having a GUI,

(b) a step of detecting, on booting the software, such booting of the software, and displaying the applicable use of the software on a screen of a display device,

(c) a step of registering in the storage unit the operating sequence of the software for utilizing the software in the use, for each of the use displayed on the menu,

(d) detecting, on selection of the use from the menu, in what location in the screen a GUI widget to be acted on next is displayed, in accordance with the operating sequence previously registered for th selected use, by detection unit, and of displaying the detected GUI widget in a highlighted fashion on the screen or picture in accordance with the detected display location for the GUI,

(e) detecting an action on the GUI widget, and

(f) instructing the detection unit, in accordance with the previously registered operating sequence, to detect in which position on the screen a GUI widget to be acted on next and displaying the GUI widget in a highlighted fashion on the screen or picture, in accordance with the detected display location of the GUI widget.

A GUI control method in still another embodiment of the present invention preferably is comprised of the following respective steps;

(a) a step of previously registering in a storage unit the applicable use of a software adapted for running on a computer, the computer having a GUI,

(b) a step of displaying the registered use in a menu on a screen of the display device and booting, on selection of the use from the menu, the software as required for the selected use,

(c) a step of previously registering in a storage unit a screenshot for utilizing the booted software in the selected use, as a cover screen,

(d) a step of hiding an inherent screen of the software booted from view and visibly displaying the registered cover screen,

(e) a step of detecting an action on a GUI widget displayed on said cover screen to display the next cover screen,

(f) a step of previously registering in the storage unit widget-relation information as to which GUI widget on the inherent screen of the software is to be acted on act in on any of the GUI widgets on the cover screen,

(g) a step of detecting, in accordance with the registered widget-relation information, in which location on the inherent screen of the software the GUI widget to be acted on next is being displayed,

(h) a step of issuing an operating event to the detected GUI widget,

(i) a step of previously registering widget-relation information as to in which GUI widget on the cover screen the data displayed on a GUI widget on the inherent screen of the software is to be copied and

(j) copying the data displayed on the GUI widget on the inherent screen of the software in the GUI widget on the cover screen in accordance with the registered widget-relation information.

A GUI control method in still another embodiment of the present invention preferably is comprised of the following respective steps:

(a) a step of previously registering in a storage unit the applicable use of a software adapted for running on a computer, the computer having a GUI.

(b) a step of previously registering a screenshot for utilizing the software in the use as a cover screen in the storage unit,

(c) a step of detecting, on booting the software, such booting, hiding an inherent screen of the software booted from view, visibly displaying the registered cover screen in its stead and displaying the applicable use of the booted software in a menu on a cover screen in a menu,

(d) a step of displaying, on selection of use from the menu, the cover screen registered for the selected use,

(e) a step of detecting an action on a GUI widget displayed on the cover screen to display the next cover screen,

(f) a step of previously registering in the storage unit the widget-relation information as to which GUI widget on the inherent screen of the software is to be actuated on actuation of which GUI widget on the cover screen,

(g) a step of detecting in which location on the inherent screen of the software the GUI widget to be acted on next is to be displayed in accordance with the registered widget-relation information,

(h) a step of issuing an operating event on the detected GUI widget.

(i) previously registering in the storage unit widget-relation information as to in which GUI widget on the cover screen data displayed on the GUI widget on the inherent screen of the software is to be cooled, and

(i) a step of copying data displayed in the GUI widget on the inherent screen of the software in the GUI widget on the cover screen in accordance with the registered widget-relation information.

### PREFERRED EMBODIMENTS

For further detailed description of the above-described embodiments of the present invention, certain preferred embodiments of the present invention are explained by referring to the drawings.

FIG. 1 shows a configuration of a first embodiment of a GUI control apparatus according to the present invention. Referring to FIG. 1, the first embodiment of the present invent ion includes use menu display unit 100, use menu registration unit 101, use select ion detection unit 102, software booting unit 103, widget detection unit 104, operational sequence registration unit 105, operation target widget indicating unit 106, operation detection unit 107 and widget display unit 108. The processing and functions of these units are realized by a program (product) executed on a computer. Meanwhile, display unit, input unit, such as keyboard or pointing device, routinely provided on a computer executing the program, are not shown in FIG. 1. The computer configuration is explained later with reference to FIG. 27.

On completion of booting of the computer, the use menu display unit 100 demonstrates the use menu on the computer screen after booting.

The “use menu” is a menu showing the applicable use(s) of the computer (what can be done on the computer) and is registered at the outset by the use menu registration unit 101.

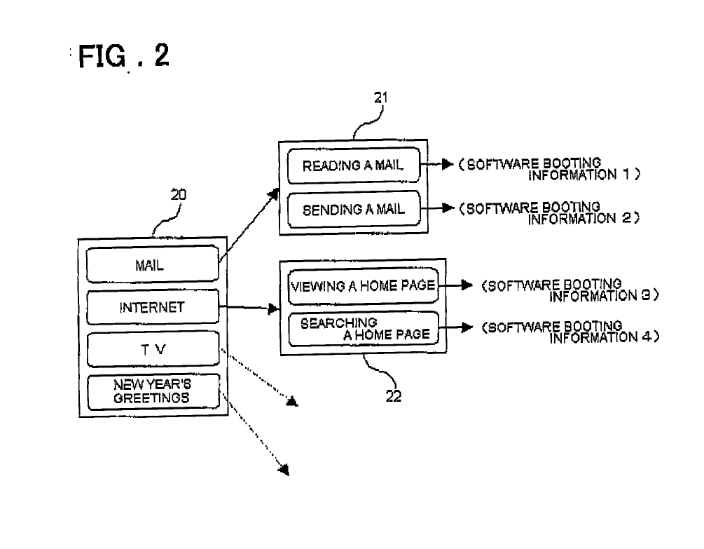

FIG. 2 schematically shows typical registration on the use menu. In the embodiment shown in FIG. 2, the use menu display unit 100 on completion of computer booting demonstrates a menu on the screen of the booted computer.

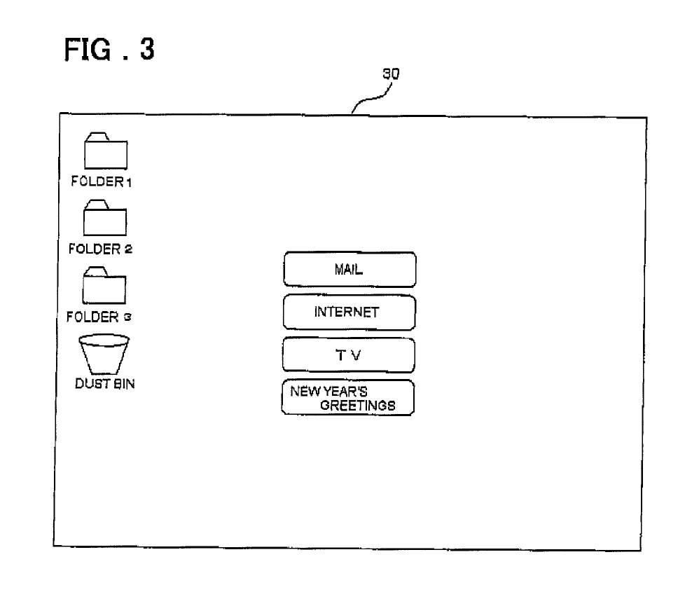

FIG. 3 shows the state of display on a computer screen. In the embodiment of FIG. 3, a screenshot (picture screen) frame 30 shows the entire screenshot, with the menu 20 being demonstrated centrally of the screenshot.

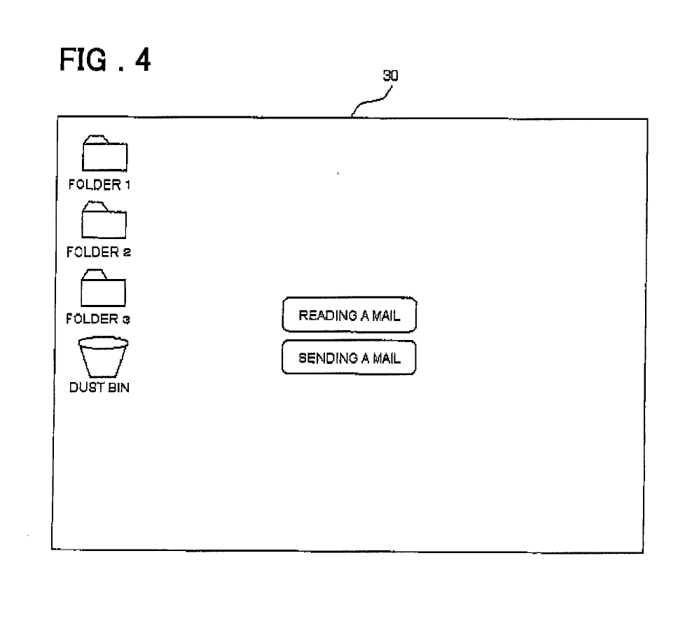

If a user clicks and selects e.g., a “mail” as a generic category of use on the screenshot of FIG. 3, the use selection detection unit 102 detects this selecting operation. Since it is noticed from FIG. 2 that the menu displayed next is a menu 21, the use menu display unit 100 demonstrates the menu 21 on the screenshot. FIG. 4 shows this state.

If the user clicks and selects the “read a mail” in the screenshot of FIG. 4, the use selection detection unit 102 detects this selecting operation. The software booting unit 103 references the information registered in the software booting information 1, with the software booting unit 103 referencing the information registered in the software booting information 1 of FIG. 2 to boot the software.

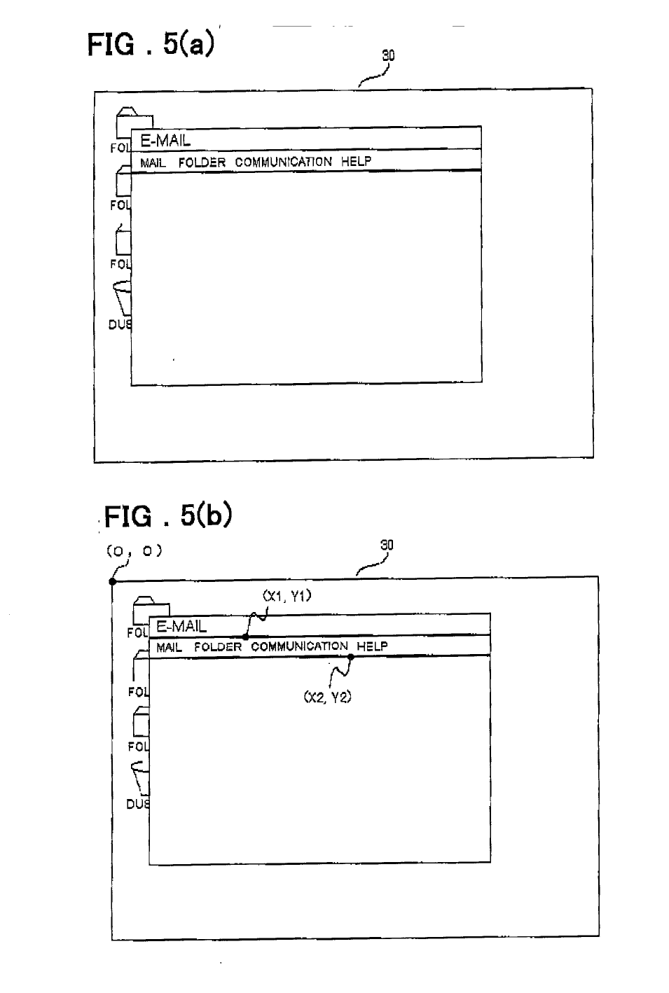

Referring to FIG. 2, parameters for booting the software necessary for “reading the mail” are registered in the software booting information 1. The software booting unit 103 boots the software in accordance with these parameters. FIG. 5a shows a typical screenshot immediately following the software booting.

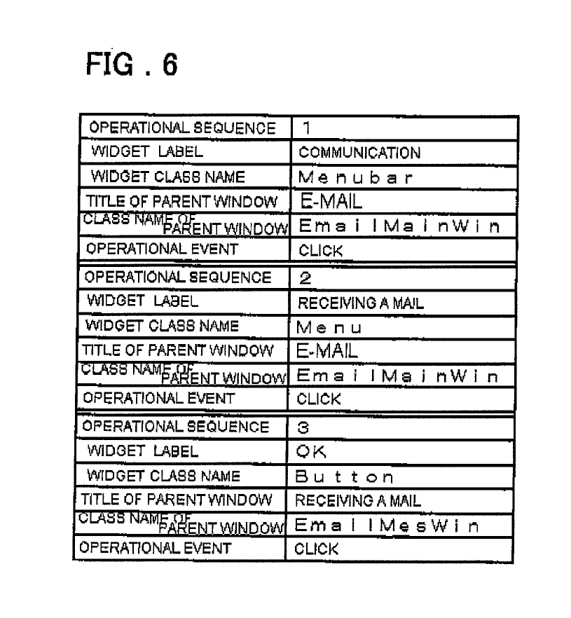

In the operational sequence registration unit 105, there is registered at the outset an operating sequence for use of each of the items (i.e., operational subclass steps under the generic category of use “Mail”) of the menu 21 of FIG. 2, such as “reading a mail” or “sending a mail” of the menu 21 of FIG. 2, or “viewing a home page” or “searching a home page” of the menu 22. By way of an example, the operating sequence for the item “reading a mail” of the menu 21 of FIG. 2 is registered as shown for example in FIG. 6.

An embodiment shown in FIG. 6 shows that the operating sequence for “reading a mail” is as follows:

(1) First, a widget having a widget label of “communication” and the class name of “Menu bar” lying on a window having a title of the “E-MAIL” and a class name of “EmailMainWin” is clicked.

(2) Next, a widget having a label “receiving a mail” and a crass name “Menu” lying on a window having a title of the “E-MAIL” and a class name of “EmailMainWin” is clicked.

(3) Finally, a widget having a label “OK” and a class name “Button” lying on a window having a title “receiving a mail” and a class name of “EmailMainWin” is clicked.

In accordance with the operational sequence registered by the operational sequence registration unit 105, the widget detection unit 104 detects in what position on the screen the widget to be operated next is demonstrated.

It is assumed that, as an example, the user has selected “reading a mail” on the screenshot shown in FIG. 4 and that the operating sequence registered for this menu item is that shown in FIG. 6.

In this case, since the widget to be acted on first is a widget having a label of “communication” and the class name of “Menubar” lying on a window having a title of the “E-MAIL” and a class name of “EmailMainWin”, it is detected in what position on the screen a widget that meets this condition is displayed.

If, in the embodiment shown in FIG. 6a, the widget is the “communication” menu in FIG. 5a, the widget detection unit 104 detects a coordinate value (x1, y1 at an upper left (end) point of the “communication” and a coordinate value (x2, y2 at a lower right (end) point of the “communication” menu as shown in FIG. 5b.

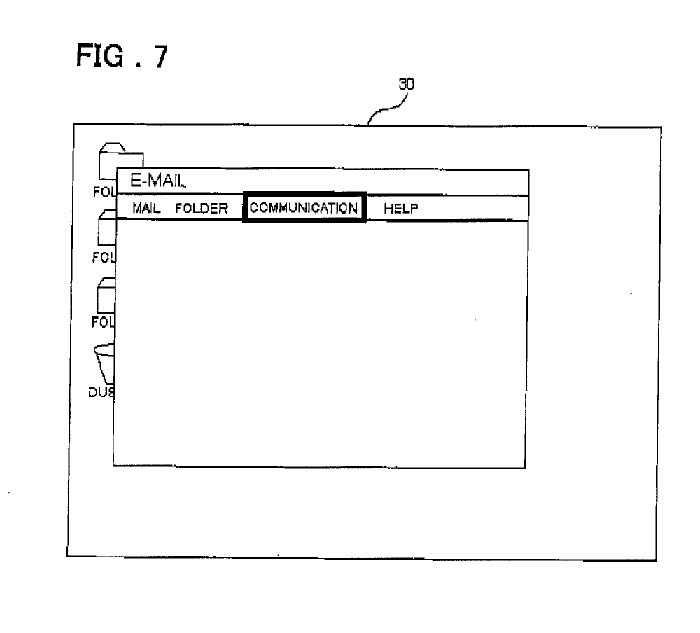

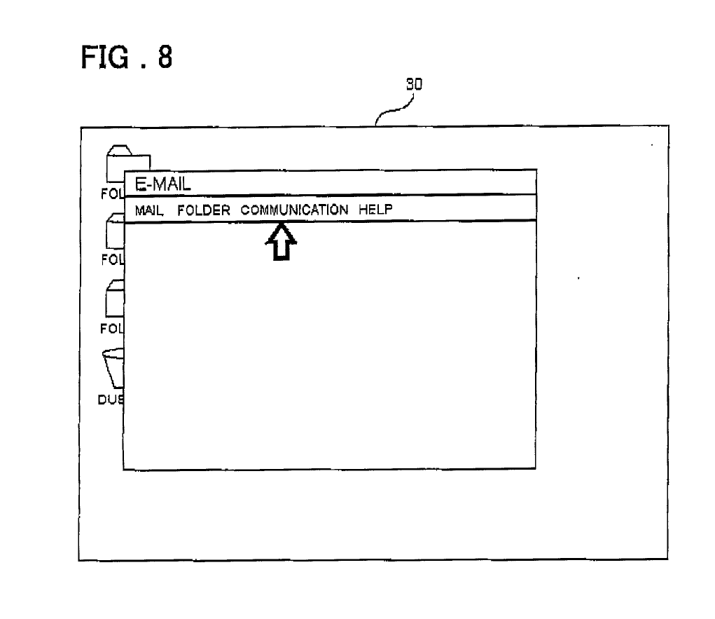

The operation target widget indicating unit 106 displays the widget detected by the widget detection unit 104 in a readily noticeable manner so that the user can recognize it instantly. This state is shown in FIGS. 7 and 8.

In the embodiments shown in FIGS. 7 and 8, the widget being acted on is highlighted by encircling it with a frame and by indicating it with an arrow, respectively. Since the widget to be acted an next is highlighted, the user may realize readily which widget is to be acted on next. However, any other suitable technique for highlighting the widget on the screenshot, such as changing an emphasizing the display color or inverting the displayed letters in luminosity may be used.

If the user acts on a widget, highlighted by the operation target widget indicating unit 106, the operation detection unit 107 detects the operation.

If the operation detection unit 107 detects the operation, the widget detection unit 104 detects the display position of the widget to be acted on next, with the operation target widget indicating unit 106 then highlighting the objective widget.

The above-described operating sequence is repeated until the entire operating sequence registered in the operational sequence registration unit 105 is finished.

The operation of the widget display unit 108 is as follows: If the widget acted on is a menu or a button, the operation thereon will be finished just on clicking. However, if the widget acted on is a text field, it is unknown at the outset how many letters are being input by the user. So, if the widget to be acted on is the text field, such a widget which clarifies (identifies) completion of inputting is demonstrated on the screenshot.

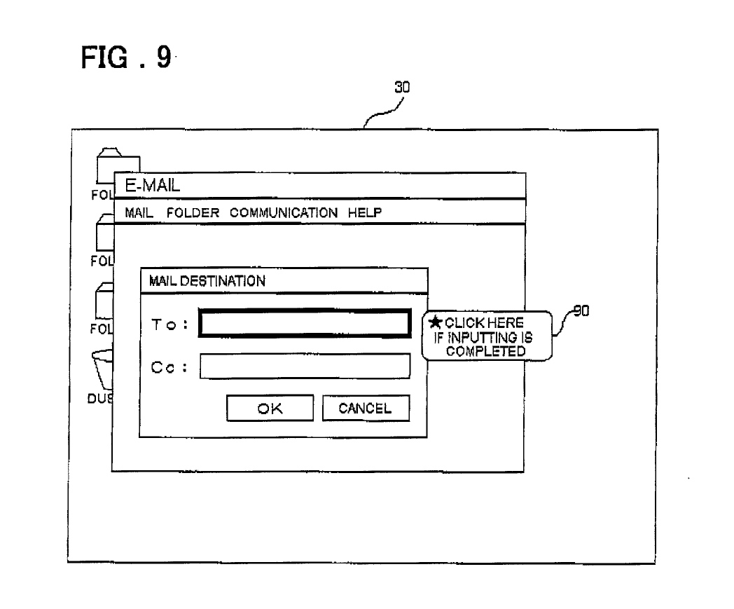

FIG. 9 shows a typical widget demonstrated by the widget display unit 108. In the embodiment shown in FIG. 9, a letter queue is input to a text field [To.] encircled by a frame. If then a widget 90 is clicked, the operation detection unit 107 detects the clicking, followed by instructing the widget detection unit 104 to detect the next widget.

Meanwhile, in case where the widget to be acted on is a text field, not “operation event=[click]” but “operation event=[letter input]” is registered. If the widget registered “operation event=[letter input]” is a widget acted on, the widget display unit 108 demonstrates a widget like the widget 90 of FIG. 9 on the screenshot. The display position of the widget 90 is determined on the basis of the display coordinate values of the widget detected by the widget detection unit 104.

Meanwhile, the screenshot configuration shown in FIGS. 2 to 9 are intended for illustrating the invention. It is to be noted that the present invention is not limited to the above-described screenshot configuration.

[Embodiment 2]

The second embodiment of the present invention is now explained. In the above-described first embodiment, the software is booted by the software booting unit 103 based on the software booting information registered at the outset in the use selection detection unit 102.

In the second embodiment of the present invention, the user pushes a software booting key on a keyboard to boot the software.

FIG. 10 shows the configuration of the second embodiment of the present invention. Referring to FIG. 10, if the software booting key on the keyboard is pushed to boot the software, a software booting detection unit 1000 detects the booting of the software to instruct the use menu display unit 100 to demonstrate the use menu for the software.

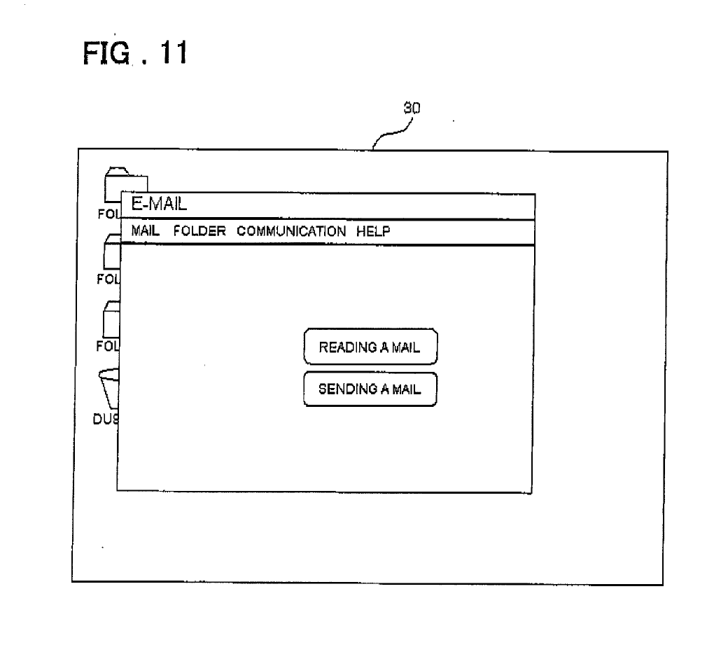

It is assumed, as an example, that a [MAIL] key on the keyboard is pushed in a state shown in FIG. 3. In this case, the software booting detection unit 1000 detects the booting of the E-MAIL software, based on the pushing of the [MAIL] key, so that the use menu display unit 100 demonstrates the use menu for the detected software on the screenshot. The result is that the screenshot (screen display) is as shown for example in FIG. 11.

In the embodiment shown in FIG. 11, the window of the software booted on pushing the [MAIL] key on the keyboard, whilst the use menu demonstrated by the use menu display unit 100 is a menu 21 of FIG. 2.

As may be seen from the above-described first embodiment, it is possible to clarify the use of the software and the operational sequence for the use without changing the program of the software having the GUI. Thus it is possible for a beginner with only poor experience in the use of the computer to exploit the software.

The second embodiment of the present invention now explained is similar to the above-described first embodiment. If, for example, [reading a mail] is selected on the screenshot of FIG. 11, the use selection detection unit 102 detects the selection sequence, with the widget detection unit 104 then detecting, in accordance with the operational sequence registered by the operational sequence registration unit 105, in which position on the screen the widget to be acted on next is displayed. The operation target widget indicating unit 106 then highlights the widget detected by the widget detection unit 104 on the screenshot. The result is that the screenshot is as shown in FIG. 7 or 8.

As may be seen from the above-described second embodiment, it is possible to clarify the use of the software and the operational sequence for the use without changing the program of the software having the GUP. Thus it is possible for a beginner with only poor experience in the use of the computer to exploit the software.

[Embodiment 3]

A third embodiment of the present invention is now explained. FIG. 12 shows the configuration of the third embodiment of the present invention. Referring to FIG. 12, a cover screen display unit 1201 demonstrates a cover screen on the as-booted computer screen.

The [cover SCREEN] is a display window screenshot demonstrated on the uppermost surface of a multi-window to the same size as the background picture size (e.g., screen size). By displaying the window of the cover screen (screenshot) to the same size as the background picture, the basic picture (screenshat) of the as-booted computer is hidden by the window of the cover screen from the sight of the user.

The cover screen demonstrated by the cover screen display unit 1201 is registered at the outset by cover screen registration unit 1200.

If the cover screen display unit 1201 demonstrates the window of the cover screen, use menu display unit 1202 demonstrates the use menu on the window of the cover screen. Similarly to the above-described first embodiment, the use menu represents the use of the computer (what can be done by using the computer) as in the above-described first embodiment, and is registered at the outset by the use menu registration unit 1202.

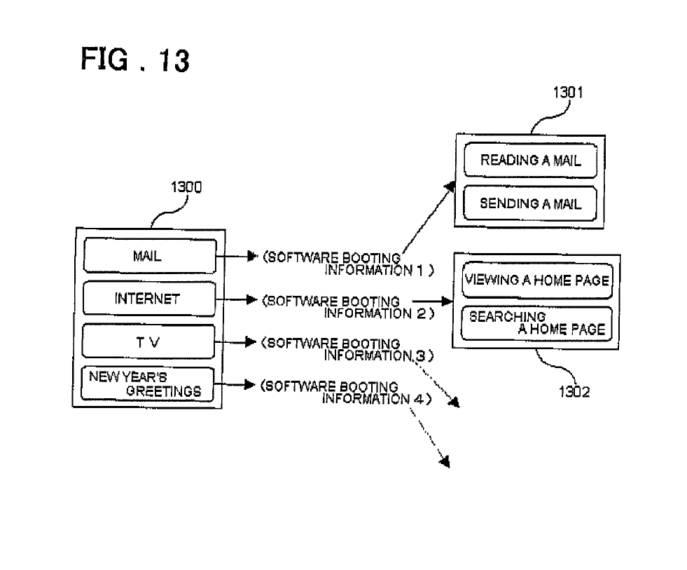

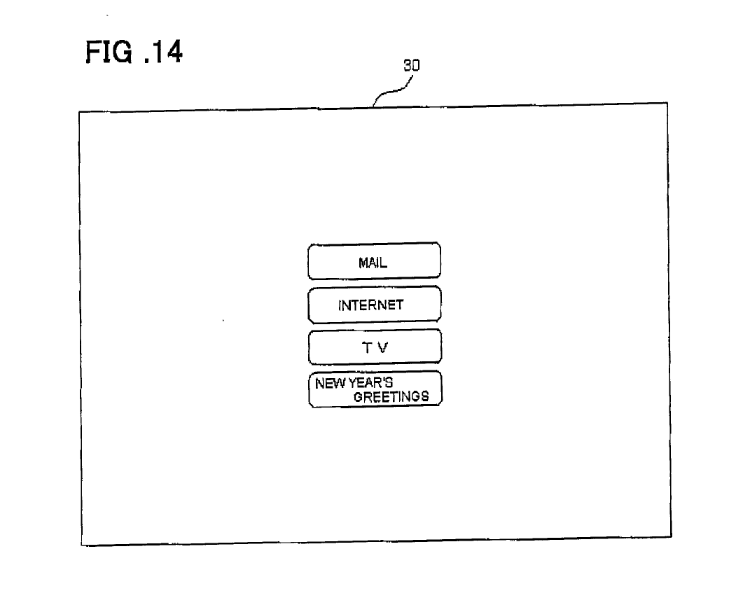

FIG. 13 schematically shows typical registration on the use menu. In the embodiment shown in FIG. 13, if the cover screen display unit 1201 demonstrates the window of the cover screen, a menu 1300 is displayed on the window, as shown as an example in FIG. 14.

If, in the screenshot shown in FIG. 14, the user clicks and selects [MAIL], the use selection detection unit 1204 detects the selecting operation. Then, software booting unit 1205 references the information registered in the software booting information 1 of FIG. 13 to boot the software. In the software booting information 1 of FIG. 13, there are registered booting parameters for the E-MAIL software, such that the software booting unit 1205 boots the software using these parameters.

On booting the software, its window is displayed on the screen. However, since the window of the cover screen with the same size as the screenshot is displayed on the uppermost layer of the multi-window, the screen of the as-booted computer is hidden by the window of the cover screen from the sight of the user.

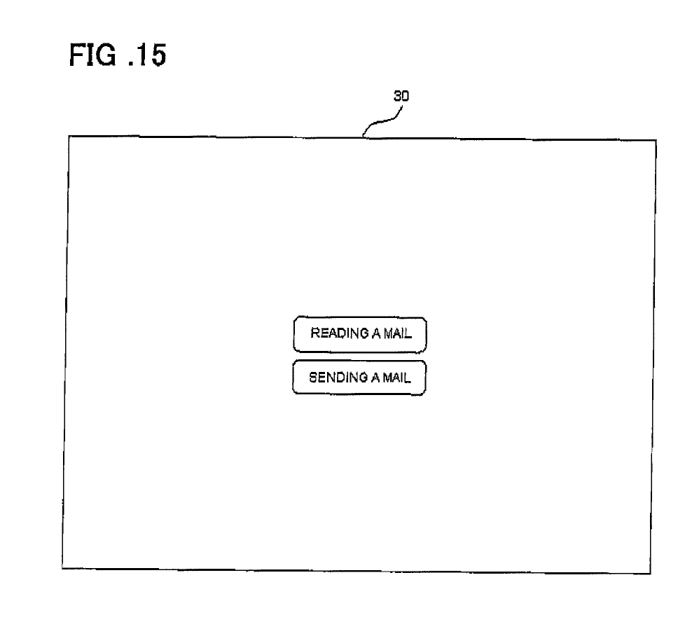

If, in the screenshot of FIG. 14, the user clicks and select [MAIL], as an example, since the menu to be displayed next is a menu 1301 (FIG. 13), user menu display unit 1203 demonstrates the menu 1301 on the screen in parallel with the software booting by software booting unit 1205. FIG. 15 shows a typical such state and displays the demonstrating screenshot for the use menu.

In widget-relation registration unit 1210, it is pre-registered which widget of the software booted by the software booting unit 1205 is to be acted on when a given widget on the cover screen is acted on.

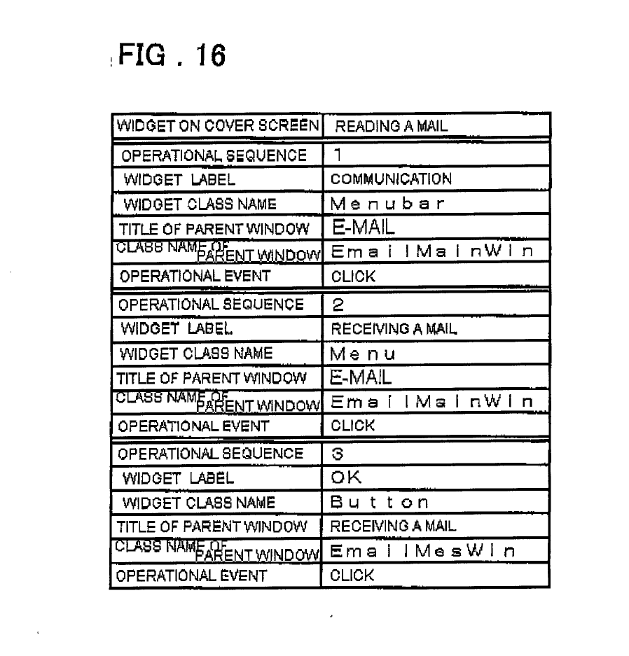

FIG. 16 shows a typical case of registration (instance of the relation with registered widgets). It is registered in the embodiment shown in FIG. 16, a widget [reading a mail] is acted on in the cover screen window, it suffices to execute the following three operations in succession for the software booted by the software booting unit 1205:

(1) First, a widget with a label “communication” and a class name “Menubar”, lying on a window with a class name “EmailMainWin” and a title “E-MAIL” is clicked;

(2) Second, a widget with a label “Receiving a Mail” and a class name “Menu”, lying on a window with a class name “EmailMainWin” and a title “E-MAIL” is clicked; and

(3) Third, a widget with a label “OK” and a class name “Button”, lying on a window with a class name “EmailMainWin” and a title “Receiving a Mail” is clicked.

If, in the screenshot shown in FIG. 15, the user clicks and selects [reading a mail], the use selection detect ion unit 1204 detects the selecting operation, and widget detection unit 1207 then detects the display position of a widget with an operating number=1 registered in the widget-relation registration unit 1210.

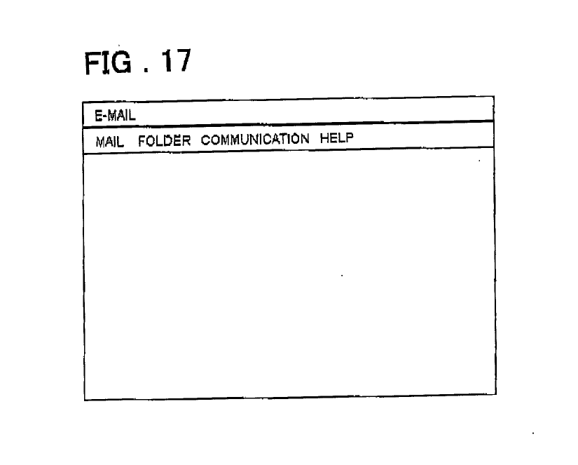

If the window of the software booted by the software booting unit 1205 is the window of FIG. 17, the widget with the operating number=1 in FIG. 16 is the [communication] menu on the window of FIG. 17, so that the widget detection unit 1207 detects the display position with the operating number=1 of the widget-relation registration table (FIG. 16) registered in the widget-relation registration unit 1210.

Since the window of FIG. 17 is displayed on a lower level surface of the cover screen window, the window of FIG. 17 is not visible to the user.

When the widget detection unit 1207 detects the display position of the [communication] menu of FIG. 17, operation event issuing unit 1208 issues an operating event of selecting the [communication] menu.

On the screenshott the cover screen window is demonstrated on the uppermost level surface of the cover screen window, with the window of FIG. 17 being on its lower level surface, the event issued by the operation event issuing unit 128 is notified not to the cover screen window but to the hidden window of FIG. 17 lying on its lower level surface.

The widget detection unit 1207 then detects the display position of the widget with the operating number=2 of FIG. 16, with the widget detection unit 1207 then issuing an operating event for the detected widget, as before.

The widget detection unit 1207 then detects the display position of the widget with the operating number=3 of FIG. 16, with the widget detection unit 1207 then issuing an operating event for the detected widget.

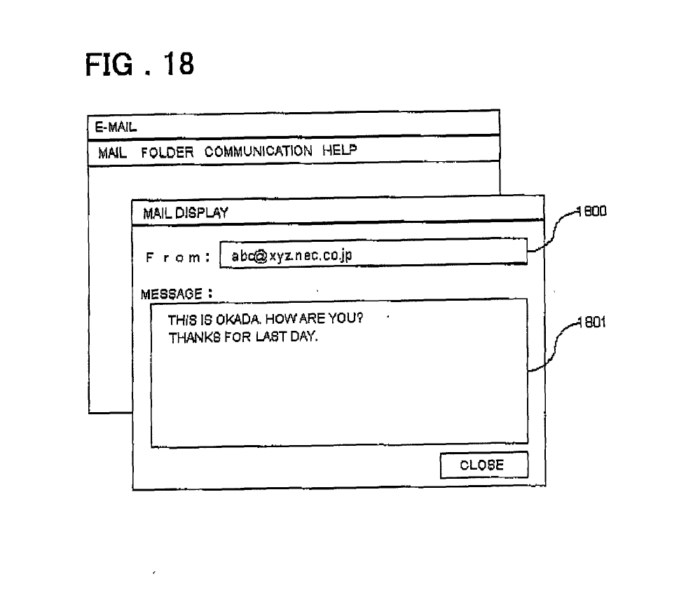

As a result, the software window booted by the software booting unit 1205 is as shown in FIG. 18.

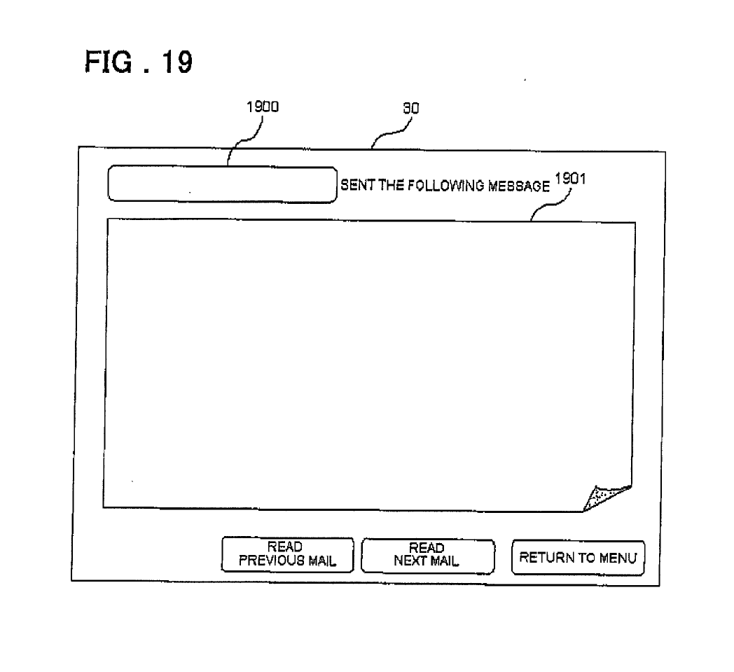

At a time point the use selection detection unit 1204 has detected the user operation of selecting [reading a mail] on the screenshot shown in Fig, 15, the cover screen display unit 1201 demonstrates a screenshot pre-registered by the cover screen registration unit 1200. This state is shown in FIG. 19.

After the operation event issuing unit 1208 has issued an operating event for the widget with the operating number=3 of FIG. 16, displayed data copying unit 1209 copies data demonstrated on the widget of the software window booted by the software booting unit 1205 on a widget on the window of the cover screen demonstrated on the cover screen display unit 1201.

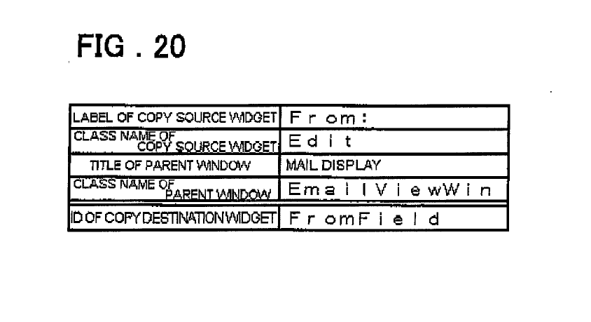

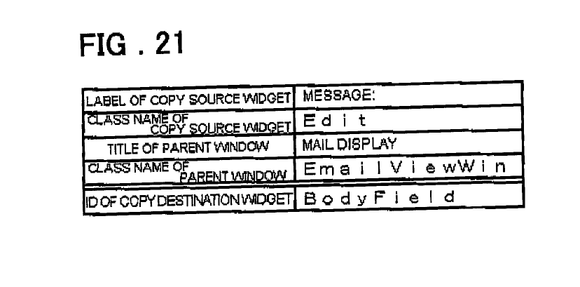

In the widget-relation registration unit 1210, it is pre-registered which data displayed on which widget is to be copied on which data. FIGS. 20 and 21 show these registration instances.

In the case of FIG. 20 it is indicated that data displayed on a widget (assumed to be a widget 1800 of FIG. 18) with the label [From,] and the class name of [Edit] lying on the window with the title [MAIL DISPLAY] and with the class name [EmailViewWin] is to be copied on a widget (assumed to be a widget 1900 of FIG. 19) with the ID (identification information) of [FromField] lying on the cover screen window.

Likewise, in the case of FIG. 21. it is indicated that data displayed on a widget (assumed to be a widget 1801 of FIG. 18) with the label [MESSAGE ] and the class name of [Edit] lying on the window with the title [MAIL DISPLAY] and with the class name [EmailViewWin] is to be copied on a widget (assumed to be a widget 1901 of FIG. 19) with the ID of [BodyField] lying on the cover screen window.

In this case, the displayed data copying unit 1209 copies the data displayed on the widgets 1800 and 1801 shown in FIGS. 18, 19, respectively, on the widgets 1900 and 1901 shown in FIG. 19.

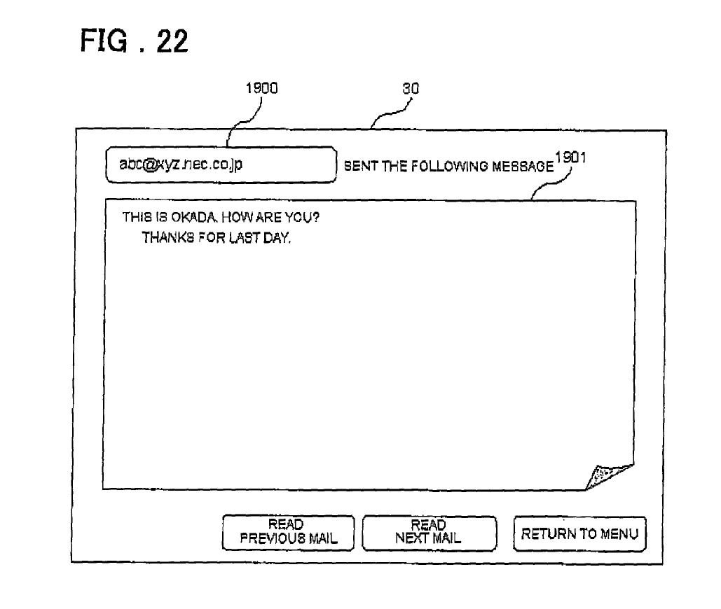

As a result, the cover screen is as shown in FIG. 22, in which it is shown that three buttons, namely [READ PREVIOUS MAIL], [READ NEXT MAIL] and [RETURN TO MENU] are provided on the cover screen window.

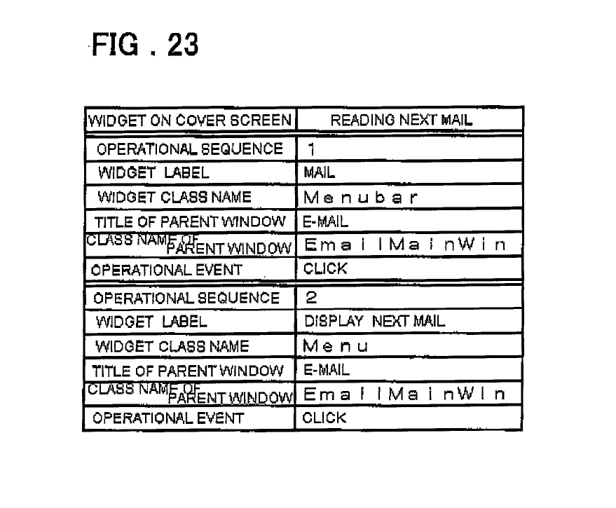

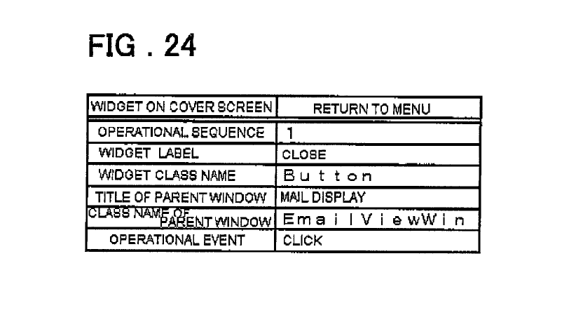

It is assumed that correspondence of the widgets to the buttons [READ NEXT MAIL] and [RETURN TO MENU] is registered by the widget-relation registration unit 1210 as shown in FIGS. 23 and 24.

In the case of FIG. 23, it is registered that, if the button [READ NEXT MAIL] is selected in the screenshot of FIG. 22, it suffices if the following two operations:

(1) operation of clicking a widget with a label [MAIL] and a class name [Menubar] lying on the window with the class name of [EmailmainWin] and with the title [E-MAIL], and

(2) operation of clicking a widget with a label [DISPLAY NEXT MAIL] and a class name [Menu] lying on the window with the class name of [EmailmainWin] and with the title [E-MAIL] are sequentially executed on the software booted by the software booting unit 1205.

Similarly, in the case of FIG. 24, it is registered that, if the button [return to menu] is selected in the screenshot of FIG. 22, it suffices if the following operation:

(1) the operation of clicking a widget with a label [CLOSE] and a class name [Button] lying on the window with the class name of [EmailViewWin] and with the title [DISPLAY MAIL] is executed on the software booted by the software booting unit 1205.

If, in the screenshot of FIG. 22, the user clicks and selects the button [READ NEXT MAIL], operation detection unit 1206 detects the operation, with the widget detection unit 1207 detecting the display position of a widget with the operating number=1 of the widget-relation registration table of FIG. 23 registered by the widget-relation registration unit 1210.

It is assumed that the window of the software, booted by the software booting unit 1205, is as shown in FIG. 18, with the widget with the operating number=1 being the [MAIL] menu on the [E-MAIL] window of FIG. 18. In this case, the widget detection unit 1207 detects the x, y) coordinate value on the left upper (end) point and the (x, y) coordinate value on the right lower (end) point of the [MAIL] menu. However, since the [E-MAIL] window and the [MAIL DISPLAY] window of FIG. 18 are displayed on a lower level surface of the cover screen, the two windows of FIG. 18 are not visible to the user.

If the widget detection unit 1207 detects the display position of the [MAIL] menu of FIG. 18, the operation event issuing unit 1208 issues an operating event for the detected widget, as before.

The widget detection unit 1207 then detects the display position of the widget with the operating number=2 of FIG. 23, with the widget detection unit 1207 then issuing an operating event for the detected widget.

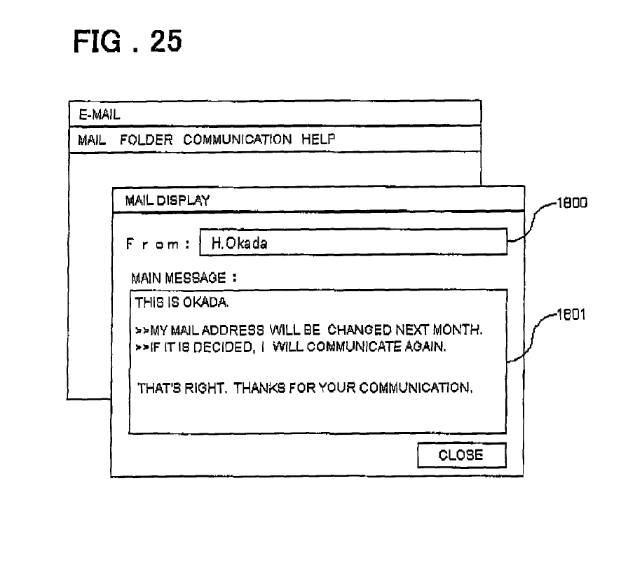

As a result, the software window booted by the software booting unit 1205 is as shown in FIG. 25,

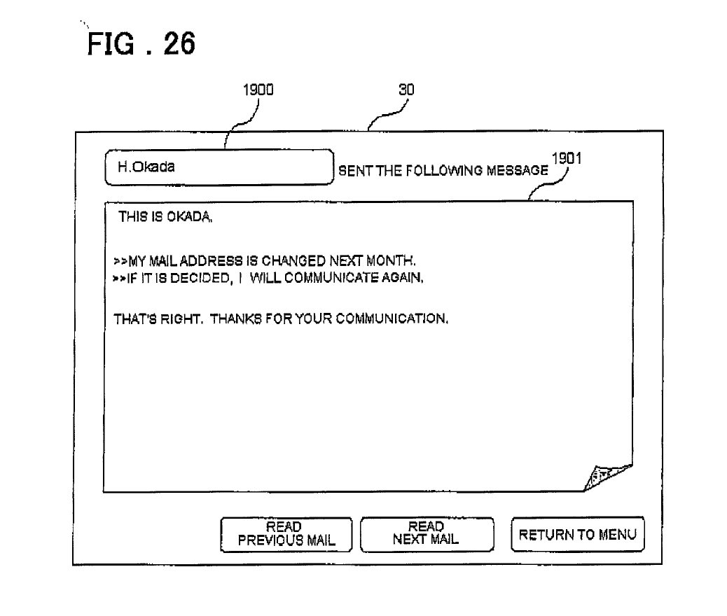

The displayed data copying unit 1209 copies the data d demonstrated on the widgets 1800, 1801 of FIG. 25 on the widgets 1900, 1901 of FIG. 22, as in the above-described embodiment. As a result, the cover screen windows as shown in FIG. 26.

If then the user clicks the button termed [RETURN T0 MENU] in the screenshot of FIG. 26, the operation detection unit 1206 a detects this operation to notify to the cover screen display unit 1201 that the menu screenshot of FIG. 14 be displayed.

The widget detection unit 1207 detects the display position of the widget with the operating number=1 in the widget-relation registration data of FIG. 24 registered by the widget-relation registration unit 1210.

If the window of the software booted by the software booting unit 1205 is as shown in FIG. 25, and the widget with the operating number=1 of FIG. 24 is a button [CLOSE] on the window [DISPLAY MAIL] of FIG. 25, the widget detection unit 1207 detects a (x, Y) coordinate value at the left upper (end) point and a (x,y) coordinate value at the right lower (end) point of the button [CLOSE].

If the widget detection unit 1207 detects a display position of the button [CLOSE] of FIG. 25, the operation event issuing unit 1208 issues an operational event of selecting the detected [CLOSE] button, as before.

The result is that the window of the software booted by the software booting unit 1205 returns to the state shown in FIG. 17.

In the third embodiment of the present invention, as may be seen from the above-described first embodiment, it is possible to clarify the applicable use of the software having the GUI and to clarify the operating sequence for this applicable use, without changing the program of the software. So, even a beginner with only little experience in using the computer may use the software.

A fourth embodiment of the present invention is hereinafter explained. In the above-described third embodiment, the software booting unit 1205 boots the software, based on the software booting information registered in the use menu display unit 1202. In the present fourth embodiment, a user pushes a software booting key on the keyboard to boot the software. FIG. 27 shows the configuration of the fourth embodiment of the present invention.

Referring to FIG. 27, if a software booting key on a keyboard is pressed to boot the software, the software booting detection unit 1000 detects the booting of the software to notify the user menu display unit 1203 that the use menu for the software be displayed.

Assume that the screenshot is in a state shown in FIG. 14 and a [MAIL] key on the keyboard has been pushed. In this case. the software booting detection unit 1000 detects that the software of the E-MAIL program has been booted by the pressing of the [MAIL] key, with the user menu display unit 1203 then causing the use menu for the detected software to be displayed on a widow of the cover screen.

The result is that the displayed screenshot is as shown in FIG. 15. The following operation is the same as that in the above-described third embodiment. That is, in the fourth embodiment, the window of the software booted on pressing the software boot key on the keyboard is displayed as a lower surface on the cover screen and hence is not visible from the user.

In the fourth embodiment of the present invention, it is again possible to clarify the applicable use of the software having the GUI and to clarify the operating sequence for this applicable use, without changing the program of the software. So, even a beginner with only little experience in using the computer may use the software.

[Fifth Embodiment]

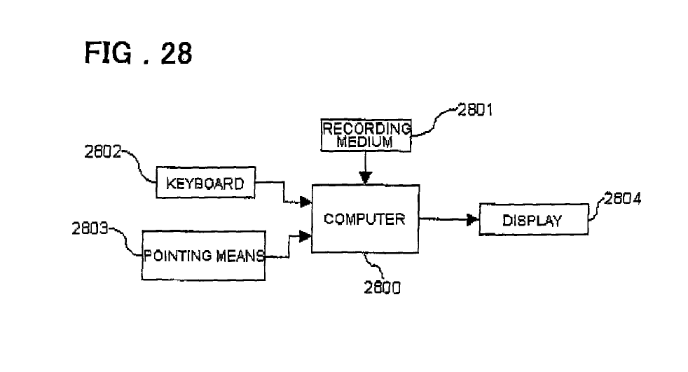

A fifth embodiment of the present invention is now explained. FIG. 28 shows the configuration of the fifth embodiment of the present invention. The present fifth embodiment of the present invention realizes the GUI control d e device of the above-described first to fourth embodiments by the executable program (GUI control program) running on a computer, as exemplified by PC or WS. FIG. 28 shows an illustrative structure of a computer. The executable program (contemplated as a program product) is recorded an a recording medium 2801 exemplified by a hard disc, a floppy disc, a CD-ROM, an MT (magnetic tape) or a DVD (digital versatile disc), and is read out to the computer 2800 for execution to cause the computer 2800 to operate a GUI control device explained in the above-described first to fourth embodiments. Output unit for outputting the operational result is a display 2804. Also, data registered in the use selection unit or in the operational sequence registration unit are recorded on a recording device provided on the computer, such as a RAM (random access memory) or on a recording medium such as a hard disc, or on the recording medium 2801, if the recording medium 2801 is recordable, so as to be read out to the computer 2801 for processing by the executable program. Note, however, the program may be supplied through Internet or other source in a running or dynamic state carried on a carrier wave.

The meritorious effects of the present invention are summarized as follows,

As described above. the following meritorious effects are achieved with the use of the GUI control method or apparatus according to the present invention:

The first meritorious effect of the present invention is that the software can be utilized even by a beginner with only poor experience in the use of the computer. The reason is that. according to the present invention, it is possible to clarify the applicable use of the software having the GUI and to clarify the operating sequence for this applicable use, without changing the program of the software.

The second meritorious effect of the present invention is that the software can be utilized even by a beginner with only poor experience in the use of the computer. The reason is that, according to the present invention, it is possible to clarify the applicable use of the software having the GUI and to display a more simplified screenshot in which only GUI widgets for the necessary functions are displayed.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A graphical user interface, termed herein throughout the claims “GUI”, control method comprising the processings of:
(a) displaying the applicable use, previously registered in a storage unit, of a software running on a computer, on a screen of a display apparatus in a menu form, and
(b) displaying a GUI widget to be operated next in a display style highlighting said widget from other widgets on said screen, in accordance with an operating sequence previously registered in said storage unit, on selection of the use on said menu,
wherein said processing of displaying of the applicable use and said processing of displaying the GUI widget are performed from one processing to another upon each operation to guide the operating sequence of realizing said selected use.

2. A GUI control method comprising,
displaying a cover screen hiding an inherent screen of a software on a display device; and
displaying the applicable use of said software in a menu form on said cover screen;
wherein if an operation on the menu on said cover screen is performed, an operation equivalent to the operation performed on said cover screen is executed on the inherent screen of said software in accordance with previously registered widget-relation information.

3. A graphical user interface GUI control method comprising:
(a) a step of previously registering in a storage unit the applicable use of a software adapted for running on a computer, said software having a GUI;
(b) a step of displaying the registered use as a menu on a screen of a display device, inputting an operational sequence of said software, as required for utilizing said software in said use, to register in said storage unit, for each use displayed on said menu; and
c) a step comprising; booting, on selection of the use from said menu, the software as required for the selected use; detecting in what location in the screen a GUI widget to be acted on next, in accordance with the operating sequence previously registered for the selected use, is displayed; and displaying the detected GUI widget in a highlighted fashion on the screen in accordance with a detected display location of said GUI widget; and
(d) a step comprising: detecting an action on said GUI widget, instructing, in accordance with said previously registered operating sequence, to detect in what position on the screen a GUI widget to be acted on next; and displaying said GUI widget in a highlighted fashion on said screen, in accordance with the detected display location of said GUI widget.

4. A graphical user interface GUI control method comprising:
(a) a step of previously registering in a storage unit the applicable use of a software adapted for running on a computer, said software having a GUI;
(b) a step of detecting, on booting said software, such booting of said software, and displaying the applicable use of said software on a screen of a display device;
(c) a step of registering in the storage unit the operating sequence of said software for utilizing the software in said use, for each of the use displayed on said menu;
(d) a step comprising: detecting, on selection of the use from said menu, in what location in the screen a GUI widget to be acted on next is displayed, in accordance with the operating sequence previously registered for the selected use, and of displaying the detected GUI widget in a highlighted fashion on said screen in accordance with the detected display location of said GUI widget;
(e) a step of detecting an action on said GUI widget: and
(f) a step of instructing, in accordance with said previously registered operating sequence, to detect in what position on the screen a GUI widget to be acted on next is displayed, and displaying said GUI widget in a highlighted fashion on said screen, in accordance with the detected display location of said GUI widget.

5. A graphical user interface GUI control method comprising:
(a) a step of previously registering in a storage unit the applicable use of at least one software adapted for running on a computer, said software having a GUI;
(b) a step of displaying the registered use in a menu on a screen the display device and booting, on selection of the use from said menu, a software as required for the selected use;
(c) a step of previously registering in a storage unit a screenshot for utilizing the booted software in the selected uses as a cover screen;
(d) a step of hiding an inherent screen of the software booted from view and visibly displaying said registered cover screen;
(e) a step of detecting an action on a GUI widget displayed on said cover screen, followed by displaying the next cover screen;
(f) a step of previously registering in said storage unit widget-relation information as to what GUI widget on the inherent screen of said software is to be acted on upon acting onto any GUI widget on said cover screen;
(g) a step of detecting, in accordance with the registered widget-relation information, in what location on the inherent screen of said software the GUI widget to be acted on next is being displayed;
(h) a step of issuing an operating event to the detected GUI widget,
(i) a step of previously registering the widget-relation information as to in which GUI widget on said cover screen the data displayed on a GUI widget on the inherent screen of said software is to be copied; and
(i) copying the data displayed on the GUI widget on the inherent screen of said software in said GUI widget on said cover screen in accordance with the registered widget correspondence information.

6. A graphical user interface GUI control method comprising
(a) a step of previously registering in a storage unit the applicable use of a software adapted far running on a computer, said software having a GUI,
(b) a step of previously registering a screenshot for utilizing said software in said use as a cover screen in said storage unit;
(c) a step of detecting, on booting said software, such booting, to hide an inherent screen of the software booted from view, thereby visibly displaying said registered cover screen in place of said inherent screen and displaying the applicable use of said booted software in a menu on the cover screen in a menu;
(d) a step of displaying, on selection of use from said menu, said cover screen being registered for the selected use;
(e) a step of detecting an action on a GUI widget displayed on said cover screen to display a next cover screen;
(f) a step of previously registering in said storage unit the widget-relation information as to what GUI widget on the inherent screen of said software is to be actuated upon actuation of any GUI widget on said cover screen;
(g) a step of detecting in what location on the inherent screen of said software the GUI widget to be actuated next is to be displayed in accordance with the registered widget-relation information;
(h) a step of issuing an operating event on said detected GUI widget:
(i) previously registering in said storage unit the widget correspondence information as to in what GUI widget on said cover screen data displayed on the GUI widget on the inherent screen of said software is to be copied; and
(j) a step of copying data displayed in the GUI widget on the inherent screen of said software in the GUI widget on said cover screen in accordance with the registered widget correspondence information.

7. The GUI control method as defined in claim 3 wherein. in executing said GUI control, there is no necessity to modify said software.

8. An information processing apparatus comprising:
a controller managing control so that the applicable use of a software is displayed in a menu form on a screen of a display device, and so that, if one use is selected on said menu. a graphical user interface widget, termed “GUI widget” to be acted on next is displayed in a highlighted fashion from others on a screen, in accordance with a previously registered operating sequence,
said controller guiding the operating sequence for realizing said selected use.

9. An information processing apparatus comprising:
a controller managing control so that a cover screen hiding the inherent screen of a software on a display device is displayed on a display device to display the applicable use of said software in a menu form on said cover screen, and so that, if an action is made on said menu of said cover screen, an action equivalent to an action on said cover screen is executed on an inherent screen of said software in accordance with a previously registered operating sequence.

10. A GUI control apparatus comprising:
(a) a use menu display unit displaying, in a menu, the applicable use of a software adapted for running on a computer, said software having a graphical user interface GUI;
(b) a use menu registration unit previously registering a use menu displayed by said use menu display unit;
(c) a use selection detection unit detecting, on selection of one use from the use menu displayed on said use menu display unit, which use has been selected;
(d) a software booting unit booting the software required for the selected use,
(e) an operational sequence registration unit previously registering the operational sequence for acting on said software in the selected use;
(f) a widget detection unit detecting in what location on the screen the GUI widget to be acted on next is to be displayed on a screenshot, in accordance with an operating sequence registered for the selected use by said operational sequence registration unit;
(g) an operation target widget indicating unit displaying the GUI widget detected by said widget detection unit in a highlighted fashion on a screenshot; and
(h) an operation detection unit detecting an action made on a GUI widget detected by said widget detection unit and instructing the widget detection unit to detect, in accordance with an operating sequence registered by said operational sequence registration unit, in what location on the screenshot the GUI widget to be acted on next is displayed.

11. A graphical user interface GUI control apparatus comprising;
(a) software booting detecting means for detecting booting of a software adapted for running on a computer, said software having a GUI;
(b) use menu display means for displaying, in a menu, the applicable use of a booted software;
(c) use menu registration means for previously registering a use menu displayed by said use menu display means:
(d) use selection detection means for detecting, on selection of the use from the use menu displayed by said use menu display means, which use has been selected,.
(e) operational sequence registration means for previously registering an operational sequence for acting on said software in the selected use;
(f) widget detection means for detecting, in accordance with an operational sequence registered for the selected use, by said operational sequence registration means, in what location on a screenshot the GUI widget to be acted on next is displayed;
(g) operation target widget indicating means for displaying the GUI widget detected by said widget detection means in a highlighted fashion on a screenshot;
(h) operation detection means for detecting an action on a GUI widget detected by said widget detection means and for instructing said widget detection means to detect, in accordance with an operational sequence registered by said operational sequence registration means, in what location on the screenshot the GUI widget to be acted on next is displayed.

12. The GUI control apparatus as defined in claim 10 further comprising:
means for displaying a GUI widget for notifying the completion of processing on a current screen;
said operation detection unit detecting an operation performed on the GUI widget detected by said widget detection unit or on the GUI widget displayed on the screen.

13. The GUI control apparatus as defined in claim 11 further comprising:
means for displaying a GUI widget for notifying the completion of processing on a current screen;
said operation detection unit detecting an operation performed on the GUI widget detected by said widget detection unit or on the GUI widget displayed on the screen.

14. A graphical user interface GUI control apparatus comprising;
(a) use menu displaying means for demonstrating on a menu the applicable use of a software operating on a computer, said software having a GUI;
(b) use menu registration means for previously registering the use menu demonstrated by said use menu displaying means;
(c) use selection detection means for detecting the use selected from the use menu demonstrated by said use menu displaying means;
(d) software booting means for booting a software necessary for the selected use;
(e) cover screen registration means for previously registering, as a cover screen, a screenshot for utilizing the booted software in the selected use;
(f) cover screen display means for hiding an inherent screen of said booted software and for visibly demonstrating the cover screen registered by said cover screen registration means in place of the inherent screen;
(g) operation detection means for detecting an operation on the GUI widget demonstrated on said cover screen to instruct said cover screen display means to display a next cover screen;
(h) widget-relation information registration means for previously registering widget-relation information as to which GUI widget on said inherent screen of said software is to be acted on depending on any GUI widget on said cover screen that has been acted on;
(i) widget detection means for detecting, depending on said widget-relation information registered by said widget-relation information registration means, in what location on the inherent screen of said software the GUI widget to be acted on next is demonstrated; and
(j) operation event issuing means for issuing an operating event on said GUI widget detected by said widget detection means;
(k) wherein the widget correspondence information is previously registered by said widget-relation information registration means, said information being as to data displayed in any GUI widget on said inherent screen is to be copied in which GUI widget on the cover screen of said software; and
(l) wherein there is provided displayed data copying means for copying the data displayed in a GUI widget on the inherent screen of said software in said GUI widget on said cover screen in accordance with said widget correspondence information.

15. A GUI control apparatus comprising:
(a) use menu registration means for previously registering the applicable use of a software;
(b) cover screen registration means for previously registering a screenshot for using said software for said use as a cover screen;
(c) cover screen displaying means for detecting the booting of said software, hiding an inherent screen of said booted software and for visibly demonstrating the cover screen registered by said cover screen registration means in place of the inherent screen;
(d) use menu displaying means for demonstrating the applicable use of said booted software as a menu on the cover screen demonstrated by said cover screen display means;
(e) use selection detection means for detecting, on selection of a use from said menu, which use has been selected:
(f) operation detection means for detecting an operation on a graphical user interface GUI widget displayed on s aid cover screen;
(g) widget-relation information registration means for previously registering widget-relation information indicating which GUI widget on an inherent screen on said software is to be actuated on actuation of any GUI widget on said cover screen;
(h) widget detection means for detecting in what location on an inherent screen of said software the GUI widget to be acted on next is demonstrated in accordance with widget-relation information registered by said widget-relation information registration means; and
(i) operating event issuing means for issuing an operating event for a GUI widget detected by said widget detection means;
(j) wherein the widget correspondence information is previously registered by said widget correspondence information registration means such that data displayed in any GUI widget on said inherent screen is to be copied in which GUI widget on the cover screen of said software; and
(k) wherein there is provided displayed data copying means for copying the data displayed in a GUI widget on the inherent screen of said software in said GUI widget on said cover screen in accordance with said widget correspondence information.

16. A computer readable program product for causing a computer h having at least a display device and an input device to execute the processing comprising the steps of:
(a) use menu displaying step of demonstrating on a menu the applicable use of a software having a graphical user interface GUI;
(b) use menu registration step of previously registering the use menu demonstrated by said use menu displaying processing;
(c) use selection detection step of detecting the use selected from the use menu demonstrated by said use menu displaying step;
(d) software booting step of booting a software necessary for the selected use;
(e) operating sequence registration step of previously registering an operating sequence for acting on said software in the selected use;
(f) widget detecting step of detecting in which location on a screenshot the GUI widget to be acted on next is displayed in accordance with an operating sequence registered for the selected use;
(g) operating target widget indication step of demonstrating the GUI widget detected by said widget detecting step in a highlighted fashion on a screenshot; and
(h) instructing the widget detecting step of detecting an operation on the GUI widget detected by said widget detecting step to detect in which location in a screenshot the GUI widget to be acted on next is displayed.

17. A computer readable program product for causing a computer having at least a display device and an input device to execute the processing comprising the steps of:
(a) software booting detection step of detecting booting of a software having a graphical user interface GUI;
(b) use menu displaying step of demonstrating on a menu the applicable use of a software having the GUI;
(c) use menu registration step of previously registering the use menu demonstrated by said use menu displaying step;
(d) use selection detection step of detecting the use selected from the use menu demonstrated by said use menu displaying step;
(e) operating sequence registration step of previously registering an operating sequence for acting on said software in the selected use;
(f) widget detecting step of detecting in which location on a screenshot the GUI widget to be acted on next is displayed in accordance with an operating sequence registered for the selected use;
(g) operating target widget indication step of demonstrating the GUI widget detected by said widget detecting step in a highlighted fashion on a screenshot; and
(h) operation detection step instructing the widget detecting step to detect an operation on the GUI widget detected by said widget detecting step to detect in which location in a screenshot the GUI widget to be acted on next is displayed.

18. The recording medium having recorded thereon a program as defined in claim 16, said step further comprising:
widget displaying step of displaying a GUI widget for notifying the completion of the step on a current screen;
said operation detection step causing said computer to execute detecting an operation on a GUI widget detected by said widget detection step or a GUI widget demonstrated by said widget display step.

19. The recording medium having recorded thereon a program as defined in claim 17, said step further comprising:
widget displaying step of displaying a GUI widget for notifying the completion of the step on a current screen;
said operation detection step causing said computer to execute detecting an operation on a GUI widget detected by said widget detection step or a GUI widget demonstrated by said widget display step.

20. A computer readable program product for causing a computer having at least a display device and an input device to execute the processing comprising the steps of:
(a) use menu displaying step of demonstrating on a menu the applicable use of a software having a graphical user interface
(b) use menu registration step of previously registering the use menu demonstrated by said use menu displaying step;
(c) use selection detection step of detecting the use selected from the use menu demonstrated by said use menu displaying step;
(d) software booting step of booting a software necessary for the selected use;
(e) cover screen registration step of previously registering, as cover screen, a screenshot for exploiting the boated software in the selected use;
(f) cover screen display step of hiding an inherent screen of said booted software and for visibly demonstrating the cover screen registered by said cover screen registration step in place of the inherent screen;
(g) operation detection step of detecting an operation on the GUI widget demonstrated on said cover screen to instruct said cover screen registration step to display said cover screen;
(h) widget-relation information registration step of previously registering widget-relation information as to which GUI widget on said inherent screen of said software is to be acted on depending on any GUI widget on said cover screen has been acted on;
(i) widget detection step of detecting, depending on said widget-relation information as to in what location on the inherent screen of said software the GUI widget to be acted on next is demonstrated; and
(j) operation event issuing step of issuing an operating event on said GUI widget detected by said widget detection step;
(k) a step of previously registering said widget-relation information as to data displayed on any GUI widget on said inherent screen of said software is to be copied in which GUI widget on the cover screen; and
(l) wherein displayed data copying step of copying the data displayed in a GUI widget on the inherent screen of said software in said GUI widget on said cover screen in accordance with said widget-relation information.

21. A computer readable program product for causing a computer having at least a display device and an input device to execute the processing comprising the steps of:
(a) use menu registration step of previously registering the applicable use of a software;
(b) cover screen registration step of previously registering a screenshot for using said software for said application as a cover screen;
(c) cover screen displaying step of detecting the booting of said software, hiding an inherent screen of said booted software and for visibly demonstrating the cover screen registered by said cover screen registration step in place of said inherent screen;
(d) use menu displaying step of demonstrating the applicable use of said booted software as a menu on the cover screen demonstrated by said cover screen display step;
(e) use selection detection step of detecting, on selection of a use from said menu, which use has been selected;
(f) operation detection step of detecting an operation on a graphical user interface GUI widget displayed on said cover screen;
(g) widget-relation information registration step of previously registering widget-relation information indicating which GUI widget on an inherent screen on said software is to be actuated upon actuation of any GUI widget on said cover screen;
(h) widget detection step of detecting in what location on an inherent screen of said software the GUI widget to be acted on next is demonstrated in accordance with said widget-relation information; and
(i) operating event issuing step of issuing an operating event for a GUI widget detected by said widget detection step;
(j) previously registering, by said widget-relation information registration step, in which GUI widget on said cover screen data displayed any GUI widget on the inherent screen of said software is to be copied; and
(k) displayed data copying step of copying the data displayed in a GUI widget on the inherent screen of said software in said GUI widget on said cover screen in accordance with said widget-relation information.

22. A graphical user interface GUI control apparatus for an information processing apparatus having a display device, a storage device, and a program-controlled processing device, comprising:
(a) a use menu displaying unit demonstrating on a menu the applicable use of a software having a GUS;
(b) a use menu registration unit previously registering the use menu demonstrated by said use menu displaying unit in a use menu;
(c) a use selection detection unit detecting the use selected from the use menu demonstrated by said use menu displaying unit on said display device;
(d) a software booting unit booting a software necessary for the selected use,
(e) an operating sequence registration unit previously registering an operating sequence for acting on said software in the selected use;
(f) a widget detecting unit detecting in what location on a screenshot the GUI widget to be acted on next is displayed in accordance with an operating sequence registered for the selected use by said operating sequence registration unit;
(g) an operating target widget indication unit demonstrating the GUI widget detected by said widget detecting unit in a highlighted fashion on a screenshot of said display device; and
(h) an operation detecting unit detecting an operation on the GUI widget detected by said widget detecting unit to instruct the widget detecting unit to detect in what location in said screen the GUI widget to be acted on next is displayed in accordance with an operational sequence registered by said operating sequence registration unit.

23. A graphical user interface GUI control apparatus for an information processing apparatus having a display device, an input device, a storage device, and a program-controlled processing device, comprising:
(a) a use menu displaying unit demonstrating on a menu the applicable use of a software having a GUI:
(b) a use menu registration unit previously registering the use menu demonstrated by said use menu displaying unit in a use menu;
(c) a use selection detection unit detecting the use selected through said input unit from the use menu demonstrated by said use menu displaying unit;
(d) a software booting unit booting a software necessary for the selected use.
(e) a cover screen registration unit previously registering a screenshot for using said booted software in the selected use as a cover screen;
(f) a cover screen displaying unit hiding an inherent screen of said booted software and visibly demonstrating the cover screen registered by said cover screen registration unit in place of the inherent screen on said display device;
(g) an operation detection unit detecting an operation on a GUI widget displayed on said cover screen;
(h) a widget-relation information registration unit previously registering widget-relation information indicating which GUI widget on an inherent screen on said software is to be actuated upon actuation of which GUI widget on said cover screen;
(i) a widget detection unit detecting in which location on an inherent screen of said software the GUI widget to be acted on next is demonstrated in accordance with said widget-relation information; and
(j) an operating event issuing unit issuing an operating event for a GUI widget detected by said widget detection unit:
(k) wherein it is previously registered by said widget-relation information registration processing unit, in GUI widget on said cover screen data displayed in any GUI widget on the inherent screen of said software is to be copied; and
(l) wherein there is provided a displayed data copying unit copying the data displayed in a GUI widget on the inherent screen of said software into a GUI widget on said cover screen in accordance with said widget-relation information.
